(19) United States
(12) Patent Application Publication
(10) Pub. No.: US 2006/0179057 A1
(43) Pub. Date: Aug. 10, 2006

(54) Security system with remote communication

(75) Inventor: Paolo Moretti, Verona (IT)

Correspondence Address: CARLSON, GASKEY & OLDS, P.C., 400 WEST MAPLE ROAD, SUITE 350, BIRMINGHAM, MI, 48009, US

(73) Assignee: Computerized Security Systems, Inc.

(21) Appl. No.: 11/052,364

(22) Filed: Feb. 7, 2005

(51) Int. Cl. G06F 17/30

(52) U.S. Cl. 707/9

(57) ABSTRACT

A security system includes a central server module designed to interface with one or more portable client modules. The server module manages access information to be sent to the client modules. The client module is a portable device designed to be carried by an authorized user and has a wireless interface that allows communication with the server module. When a user wishes to obtain an access code at a given time, the user logs into the server module via the client module. The central server verifies that the user is authorized to receive the access code for that particular time and securely transmits the access code to the client module. By transmitting access codes over a secure wireless system, the invention eliminates the need for a separate human operator to provide the access codes to the user for opening a lock.

### TECHNICAL FIELD

The present invention relates to security systems, and more particularly to a security system with perpetually changing access codes.

### BACKGROUND OF THE INVENTION

Applications requiring heightened security, such as safes accessed by armored car personnel, often use electronic access codes to limit access to the safe. To ensure that the combination cannot simply be observed and recorded to obtain unauthorized access, the access code is perpetually changed over time. Attempts to access the safe on different days and even different times of day will require different access codes.

One known type of security system allows authorized personnel to obtain the current access code by calling a central station where the access code is generated by a computer. A human operator at the central station informs the personnel of the generated access code so that the personnel can, for example, open a safe. This system is effective in maintaining security. However, it requires an additional person to act as an operator, increasing labor costs as well as introducing the potential for a security leak through the additional person. Moreover, using a central operator tends to be an inefficient way to transmit access information.

Another system is composed of a lock, one or more “Dallas” keys, a central server where all information is stored, and a computer client form which users can have access to at the central server in order to manage and set up locks. Locks are initially installed and configured inside the central server, lock configuration is downloaded to a setup Dallas key. The lock acquires the new configuration when the setup Dallas key is read by the lock. Users opening codes can be static (users can change the combination) or dynamic (one-time codes). One-time codes are generated on the server and retrieved from computer clients. One-time codes can have limited time extension, and they can be generated in advance (i.e., this code will open next week on Tuesday). Locks can be grouped inside routes, and each user can be assigned a different time period. Lock features include time delay option and time stamped audit capability.

This system is a fully centrally controlled access system for safe locks. As the one-time codes and the lock configuration can be delivered to local client computer through a network, there is no need of a central station operator to supervise lock access. Locks are not hard-wired to the network, with information delivered to the locks through the Dallas key.

Another system manages and controls remote safes through a hard-wired network. This system is composed of locks (up to five with the same entry) and an entry unit. The entry unit can be hard-wired to a network. Locks are managed on a central server database that can monitor locks access, can change lock configuration (enable/disable users, change time permissions, etc.), can allow access to the lock on real time, and can download time stamped audit from the lock.

Central station administrators setup lock access permission, configuration and users' privileges. Setup information is delivered to the locks so that new configuration will affect the next access by the on-site users.

There is a desire for a more streamlined system that can provide perpetually changing access codes to authorized personnel while maintaining or even increasing security.

### SUMMARY OF THE INVENTION

The present invention is directed to a security system that eliminates the need to provide a human operator at a central location. The system includes a central server module designed to interface with one or more portable client modules. The server module manages access information to be sent to the client modules. The client module is a portable device designed to be carried by an authorized user and has a wireless interface that allows communication with the server module.

When a user wishes to obtain an access code at a given time, the user logs into the server module via the client module. The central server verifies that the user is authorized to receive the access code for that particular time and securely transmits the access code to the client module. By transmitting access codes over a secure wireless system, the invention eliminates the need for a separate human operator to provide the access codes to the user.

### BRIEF DESCRIPTION OF THE DRAWINGS

FIG. 1 is a representative diagram of a security system according to one embodiment of the invention;

FIG. 2 is a chart illustrating one example of various user authorizations for the security system;

FIG. 3 is a flow diagram illustrating a process for adding a new lock to a server module in the inventive system;

FIG. 4 is a flow diagram illustrating a process for initializing a new lock in the inventive system;

FIG. 5 is a flow diagram illustrating a process for adding or modifying a user profile in the inventive system; and

FIG. 6 is a flow diagram illustrating a lock opening process conducted via the inventive system according to one embodiment of the invention.

### DETAILED DESCRIPTION OF THE PREFERRED EMBODIMENT

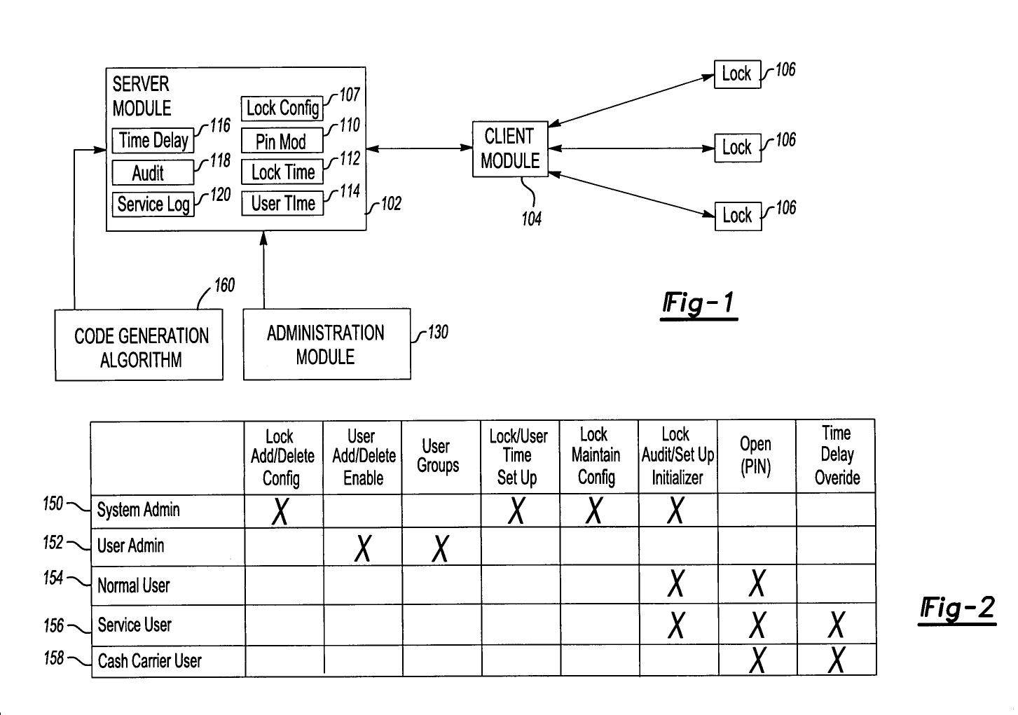

FIG. 1 is a representative diagram of a security system 100 according to one embodiment of the invention. The system 100 includes a central server module 102 and one or more portable client modules 104 that communicate securely and wirelessly with the server module 102. The server module 102 may be implemented as a software application in a dedicated central computer. The server module 102 contains the access information needed to access secure locations (e.g., safes), which have associated locks 106, and software applications used to manage communication sessions with the client modules 104. Communications between the server module 102 and the client modules 104 can be conducted via any known communication protocol and encrypted via any known encryption method.

The server module 102 provides various functions, including managing multiple client requests, validating client modules 104, auditing locks, conducting real-time lock monitoring through the client modules 104, and conducting access validation. The server module 102 includes a lock configuration application 107 that is generally used to configure the lock 106 and store its associated information and operational parameters. In one embodiment, the information stored in the server module 102 includes a password and personal identification number (PIN) modification application 110 to allow an administrator to log into the server module 102 change the password and/or PIN access code associated with a given user. The information may also include a lock time period application 112 for defining valid time periods when a lock 106 can be accessed; in one embodiment, there may be a minimum number (e.g., four) of valid time periods per day, and different time periods may be assigned for different days of the week. The lock time periods themselves may be assigned to individual locks 106, to groups of locks 106, or by specific lock locations.

The server module 102 may also contain a user time period application 114 that defines valid time periods for allowing selected users to access the locks. Specific user time periods may be assigned to specific users or can be assigned to a group of selected users. In one embodiment, if no user time period 114 is assigned, access of the lock will be controlled by the lock time period 112. Moreover, user time periods 114 should be prioritized to override lock time periods 112; that is, access by specific users overrides general access at a given lock time.

Other applications that may be stored in the server module 102 include a time delay application 116 that can be programmed to delay opening of a lock even after a user has been authorized, a lock audit application 118 that maintains downloadable records of a selected number of lock operations, and a server log application 120 that maintains a log of a selected number of operations on the server module 102. Any or all of the applications described above may be included in any combination in the server module 102.

Like the server module 102, the client module 104 may also be implemented as a software application. In the case of the client module 104, however, the application is preferably implemented on a portable computer, such as a hand-held device 120. The client module 104 is used to log into the server module 102 from a lock site and to access the locks for opening.

The system 100 also includes an administration module 130 in communication with the server module 102. The administration module 130 may be a software module loaded on a computer that has access on the same network as the computer executing the server module 102. The administration module 130 provides a user interface through which the server module 102 can be managed. In one embodiment, the administration module 130 allows a user to manage locks controlled by the system 100, the list of authorized users, access conditions, and to monitor and audit operation of the system 100.

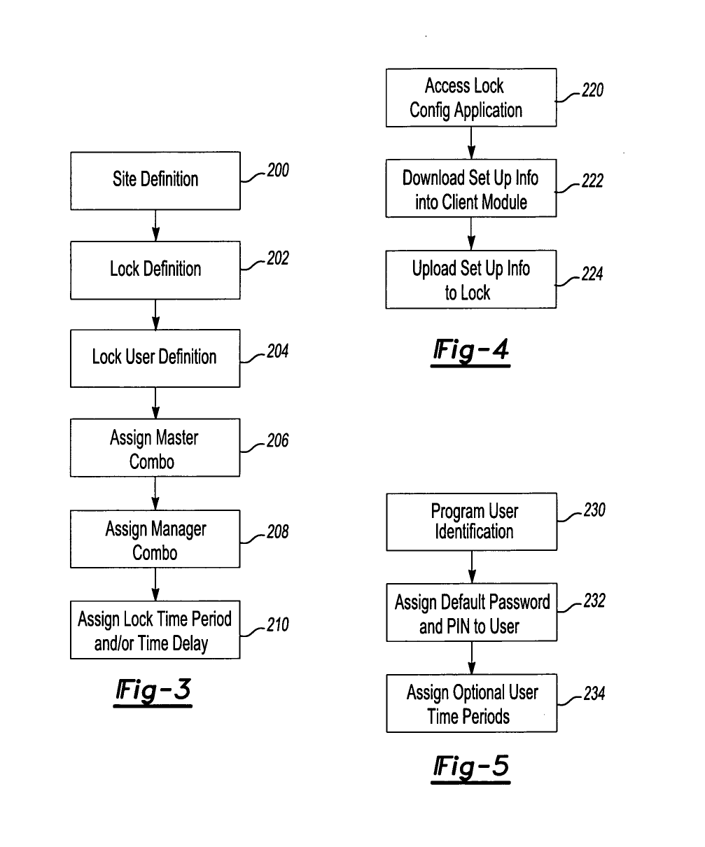

To maintain high security levels, different types of users of the system 100 are given different levels of privileges. FIG. 2 is a chart illustrating one example of different users and the privilege level assigned to each user. In this example, the users include a system administrator 150, a user administrator 152, a normal user 154, a service user 156, and a cash carrier user 158. All of the users have an associated user name and password to access the system. The system administrator 150 is allowed to access server administration features through the administration module 130 to add, delete, and configure locks in the system, set up lock time periods and user time periods, and manage lock maintenance (e.g., synchronization, auditing, etc.). The user administrator 152 is allowed to access user administration features through the administration module to add, delete, enable, and disable users and to also assign locks or lock groups to users or user groups. As can be seen in the Figure, both administrator roles have high levels of privileges and control over the operation of the system.

Users of the system are given different access privileges depending on the specific reasons for their access. In this example, normal users 154 (e.g., anyone who needs to open the lock) are simply given the privilege of being able to open the lock when they enter the lock access code (e.g., a 7-digit PIN). Note that if there is a time delay programmed into the lock, the lock will delay opening the lock for the programmed time delay period. Service users 156 (e.g., people who service the locks as well as access them) are given privileges in addition to opening privileges; in this example, service users 156 are also allowed to setup and initialize locks, audit locks, and optionally override any time delay on the lock. Cash carrier users 158 (e.g., people who deliver cash to the safe) are given immediate access and opening of the lock, regardless of any time delay.

A code generator algorithm 160 perpetually generates new codes to ensure that the code is never static, improving security. The code generator algorithm 160 communicates with the server module 102 and sends its generated codes to the server module 102. A given lock 106 will use the generated code as a one-time code to open the lock 106, as will be described in greater detail below. In other words, the generated code will be valid only for one lock and one user at one time.

Adding a new lock to the server module 102 database is a simple process and is conducted at the location of the server module 102 through the user interface of the administrative module 130. One embodiment of the lock adding process is shown in FIG. 3. To add a new lock, the process first involves defining a “site” that identifies the details of the lock's location, such as the customer/bank name, the location name, and address (block 200). Next, the lock itself is defined by giving a name to the lock and identifying the safe or other secured item on which the lock is installed (block 202). The users of the lock are defined by selecting which types of users (e.g., normal, service, and/or cash carrier) are allowed to access the lock (block 204).

The lock combinations are programmed to include a master combination (block 206) and a manager combination (block 208). In one embodiment, the same master combination is assigned to all locks within the same system (e.g., all of the locks at one site), while each lock is assigned a unique, individual manager combination. Lock time periods and/or a time delay is also assigned to the lock to complete the lock addition process (block 210).

Once the new lock has been entered into the server module 102 database, it needs to be initialized so that it will be active and accessible via the client module 104 on the portable device 120. FIG. 4 shows one possible initialization process that would be conducted by a service user. In this example, the client module 104, which has a lock set up application programmed thereon, is taken on-site to the location of the lock to be initialized. At this point, the lock to be initialized is in a pre-setup mode. To start the initialization process, the service user logs into the server module 102 and accesses the lock configuration application 107 (block 220). The server module 102 then downloads setup information to the client module 104 in the portable device 120 (block 222). The downloaded information may include, for example, lock configuration data, the lock's unique serial number, master combination, manager combination, and the initial combination for the users. The setup information is then uploaded from the portable device 120 to the lock, thereby synchronizing the information in the lock 106 with the information on the server module 102 (block 224).

One possible process for adding/modifying a user to the server module 102 database is shown in FIG. 5. This process is conducted by the user administrator 152 and involves programming a new user definition into the server module 102 by entering the user's personal information (e.g., name, address, etc.), the user type (i.e., normal, service, or cash carrier) and the username identifying the user (block 230). The user administrator 152 also assigns a default password and PIN number to the new user (block 232). If desired, user time periods may also be assigned to the user (block 234).

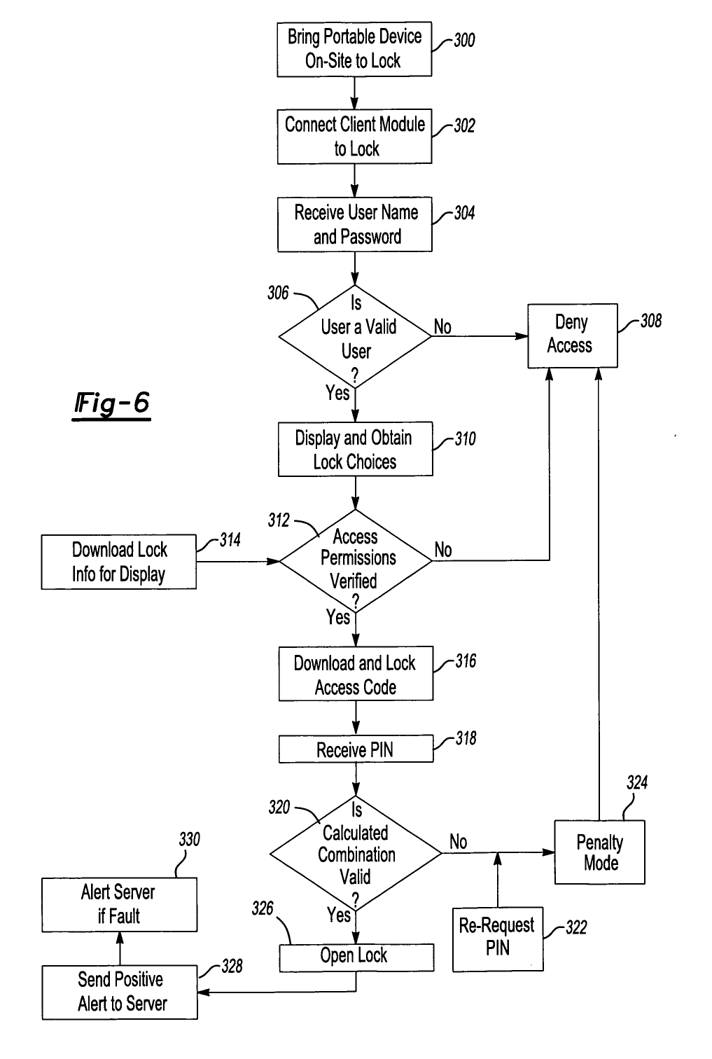

One example of a process for accessing the lock via the inventive system is shown in FIG. 6 to open the lock 107, the user needs to bring the portable device 120 containing the client module 104 on site to the location of the lock 106 to be opened (block 300). The portable device 120 containing the client module 104 is then connected to the lock 106 via any known interface, such as a wireless interface or cable (not shown) (block 302). This allows the client module 104 to communicate with the lock 106 and therefore with the server module 102.

Once a communication session is opened between the client module 104 and the server module 102, the user will attempt to log into the server module 104 via the portable device 120 by entering a username and password (block 304). The server module 102 checks the entered username and password with the information stored in the server module 102 database to determine whether the user is a valid user (block 306). If the user is not a valid user, access will be denied (block 308). In one embodiment, the server module 102 will deny further access attempts using a given username if there are a selected number of failed access attempts with the same username.

If the user is a valid user, the client module 104 will log into the server module 102 and provide the user with the option to choose which lock 106 to access (block 310). In one embodiment, the client module 104 will provide the user with a “search” option to allow the user to scroll through a list of user-enabled locks and to select the desired lock from the list. The client module 104 will also provide an “acquire” option, which allows the user to enter the unique serial number of the lock directly into the portable device 120 and send it to the server module 102.

Once the lock 106 to be accessed has been identified and selected, the server module 102 will verify access permissions for the user and for the lock 106 (block 312). In other words, the server module 102 will check to make sure that the current user is indeed authorized to access the lock 106 at that time. The server module 102 will also download any information required to open the lock 106 to the client module 104 and, if needed, display it to the user or otherwise execute the downloaded information (block 314). If, for example, there is a time delay associated with the lock 106, it will indicate this on the portable device 120 and inform them of the delay. If there is a time lock and the user is outside of the permissible unlocking time period, the portable device 120 will indicate an “access denied” message. Similarly, if the user does not have permission to open the lock 106, a “not valid user for the lock” message will appear on the portable device 120.

If all of the user permissions are acceptable (i.e., if the user is authorized to open the lock at that time), the server module 102 transmits a one-time valid access code to the client module 104 (block 316). As noted above, this one-time access code is generated by the code generator algorithm 160 and is valid only for that lock 106 and that user only for that time, until a lock bolt switch (not shown) is detected.

The client module 104 also requests the user to enter the user's associated PIN into the client module 104 (block 318). Once the client module 104 has received the one-time valid access code and the user's PIN, the client module 104 calculates the combination needed to open the lock with a proprietary algorithm using the one-time access code and the user's PIN. The resulting combination is then sent to the lock 106 and checked by the lock 106 to determine if it is valid (block 320).

If the combination is not valid, the portable device 120 displays a request to enter the PIN again (block 322). If an incorrect PIN is entered a pre-selected number of times, the lock 106 will enter a penalty mode (block 324) and deny access (block 318). If the combination is valid, an “open lock” message will appear and the lock 106 will unlock (block 326).

In one embodiment, the client module 104 monitors the status of the lock bolt switch while, for example, the safe is opened. The client module 104 will continue monitoring and check whether the lock bolt switch moves back to the closed position, indicating that the lock 106 is relocked, and send a positive acknowledgement to the server module 102 of the closing (block 328). If a communication failure occurs between the lock 106 and the client module 104 or between the client module 104 and the server module 102 while the lock bolt switch is still open, the server module 102 generates an alarm (block 330).

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A security system, comprising:
a server module containing access information for accessing a plurality of locks; and
at least one client module in wireless communication with the server module, wherein the client module is portable and receives an access code from the server module for unlocking said at least one of said plurality of locks.

2. The security system of claim 1, wherein the server module is a software application on a central computer.

3. The security system of claim 1, wherein said at least one client module is a software application on a portable computer.

4. The security system of claim 3, wherein the portable computer includes an interface to form a communication link between said at least one client module and at least one of said plurality of locks.

5. The security system of claim 1, wherein the server module comprises at least one application of a lock configuration application, a personal identification number (PIN) modification application, a lock time period application, a user time period application, a time delay application, an audit application, and a server log application.

6. The security system of claim 1, further comprising an administration module in communication with the server module, wherein the administration module acts as a user interface for managing the server module.

7. The security system of claim 6, wherein the server module is a first software application in a first computer, the administration module is a second software application in a second computer, and wherein the first and second computers are on the same network.

8. The security system of claim 1, further comprising a code generation algorithm in communication with the server module, wherein the code generation algorithm generates an one-time valid access code that is valid for only one lock and one user at one time.

9. The security system of claim 1, further comprising the plurality of locks, wherein each of said plurality of locks is adapted to communicate with the server module through the client module.

10. A method of controlling access to a lock in a security system having a server module containing access information for accessing a lock and at least one portable client module, the method comprising:
generating an access code for opening the lock;
transmitting the access code from the server module to the client module via a wireless connection between the server module and the client module; and
validating the access code with user information to determine whether to provide access to the lock.

11. The method of claim 10, wherein the user information is a personal identification number (PIN), wherein the method further comprises calculating a combination based on the access code and the PIN, and wherein the validating step comprises validating the calculated combination.

12. The method of claim 11, wherein the access code is a one-time valid access code that is valid for only one lock and one user at one time.

13. The method of claim 10, wherein the validating step comprises:
receiving at least one of a username and a password; and
denying access if at least one of the username and password is not valid.

14. The method of claim 13, wherein the validating step further comprises checking at least one access permission associated with the username.

15. The method of claim of claim 14, wherein the access permission is based on at least one of a user privilege level, a lock time, a user time, and a time delay.

16. The method of claim 11, further comprising initializing the lock by:
downloading set up information including lock identification information and at least one combination from the server module to the client module; and
uploading the set up information from the client module to the lock.
